(19) United States
(12) Patent Application Publication
(10) Pub. No.: US 2025/0145856 A1
(43) Pub. Date: May 8, 2025

(54) BARRIER COATING COMPOSITIONS AND METHOD OF USE

(71) Applicant: SOLENIS TECHNOLOGIES, L.P., Wilmington, DE (US)

(72) Inventor: Ming Liu, Mönchengladbach (DE)

(73) Assignee: SOLENIS TECHNOLOGIES, L.P., Wilmington, DE (US)

(21) Appl. No.: 18/938,354

(22) Filed: Nov. 6, 2024

Related U.S. Application Data
(60) Provisional application No. 63/596,640, filed on Nov. 7, 2023.

(51) Int. Cl. C09D 191/06; C09D 101/02; D21H 19/18; D21H 19/34

(52) U.S. Cl. CPC C09D 191/06; C09D 101/02; D21H 19/18; D21H 19/34

(57) ABSTRACT

Provided is a composition that includes a wax combined with a nanocellulose. The composition can be applied to a substrate leading to a better wax coverage with reduced porosity that provides for improved oil, grease, gas, water, and water vapor barrier properties to the coated articles.

### CROSS-REFERENCE TO RELATED APPLICATIONS

This application claims the benefit of U.S. Provisional Patent Application No. 63/596,640, filed 7 Nov. 2023, the entire contents of which are hereby incorporated by reference.

### TECHNICAL FIELD

Provided is a composition that includes a wax formulated with a nanocellulose selected from microfibrillated cellulose (MFC), nanofibrillated cellulose (NFC), microcrystalline cellulose (MCC), nanocrystalline cellulose (NCC), and combinations thereof. The composition can be applied to a substrate leading to a better wax coverage with reduced porosity that provides for improved water, water vapor, gas, grease, and oil barrier properties to the coated articles.

### BACKGROUND

Paper products are frequently sized or coated in order to form a barrier against gases such as moisture vapor and liquids such as water, oils, and greases. Wax coated paper and paperboard are widely used to protect fresh fruit, vegetables, fish, and poultry during storage and shipping.

In addition to acting as a barrier, the coating also strengthens and stiffens the paper or paperboard under wet or humid storage conditions.

The wax coating formulations applied to paper and paperboard are well known in the pulp and paper industry. Coating waxes typically have hydrocarbon chains containing from about 16 to about 40 carbon atoms and melting points of from about 30 degrees Celsius (° C.) to about 85° C. Paraffin and microcrystalline waxes are two such waxes commonly used in coated paper and paperboard applications, and natural waxes are a more environmentally friendly alternative to the petroleum-based waxes being used increasingly more in coated paper and paperboard for food packaging applications. Natural waxes such as beeswax, carnauba wax, candelilla wax, and sugarcane wax are often used in the waxing of fruit and vegetables. There are four commonly used methods of applying wax coatings to paper and paperboard. One method for coating at low wax addition levels (less than 5% by weight) uses a pre-made aqueous wax dispersion. The wax dispersion can be added to the wet end of the paper machine, on a size press, or on an off-machine coater. In the other three methods, curtain coating, wax impregnation, and cascade coating, the coating is typically applied as a molten wax at addition levels of at least 3% by weight of the coated board. A curtain coater applies a thin layer of wax onto one side of the paper or paperboard.

Typical addition levels range from about 5% to about 15% wax based on the total weight of the coated paper or paper board. Wax-impregnated paper or paperboard is made by passing the paperboard through a nip flooded with molten wax. Due to its low surface tension and the pressure applied in the nip, the wax penetrates evenly throughout the paper or paperboard. Wax addition levels for impregnated paper or paperboard range from about 12% to about 20% of the total weight of the coated paper or paperboard. Cascade wax coatings are applied to cut, glued, finished sections of corrugated paperboard (e.g., combined liner/corrugated medium/liner). A section of corrugated paperboard is passed under a stream of molten wax, completely coating the flutes and outside surfaces of the paperboard. Wax addition levels for cascade coatings can range from about 20% to about 50% of the total weight of the coated paper or paperboard.

Wax dispersions have been used extensively in aqueous polymeric coatings for surface functional barriers such as water, water vapor, gas, grease, and oil barriers. However, it has been found that wax dispersions alone cannot offer sufficient oil and gas/vapor barriers for most paper substrates due to the presence of cracks after coatings dry on the surface of, for example, a paper substrate, in particular for the high crystalline waxes (e.g., fully hydrogenated vegetable oil). In addition, wax-coated paper substrates are found sensitive to hot pressing (elevated temperatures and high pressures), which limits the use of wax dispersion in some applications where elevated temperatures and high pressures are involved (e.g., wet and dry molding).

Wax dispersions are usually coated on paper substrates for water barriers. An acceptable water barrier is usually achieved despite the fact that some microcracks may occur and be present on the surface of the substrates. The presence of microcracks or cracks allows for oil, gas, water, and water vapors to penetrate the barrier. A closed wax film without the presence of cracks would further improve the water resistance, and it would also offer other barrier properties such as oil, grease, gas, and water vapor barriers. Therefore, there is still a need to find a composition that can improve oil, grease, gas, water, and water vapor barrier properties and resistance to hot pressing to expand the applications of wax-based coating formulations in coated paper, paperboard, and molded fiber, especially for food packaging applications.

To that end, it was observed that by adding a nanocellulose, such as microfibrillated cellulose (MFC), nanofibrillated cellulose (NFC), microcrystalline cellulose (MCC), nanocrystalline cellulose (NCC), and combinations thereof, to a wax formulation, the formulations provided improved barrier properties to the coated article. Microfibrillated cellulose (MFC) and nanofibrillated cellulose (NFC) are produced from cellulose pulp via mechanical grinding and have an extraordinarily high surface area and a unique interpenetrated network structure. Microcrystalline cellulose (MCC) and nanocrystalline cellulose (NCC) are also refined wood pulp and can be synthesized by combining different processes such as reactive extrusion, mechanical grinding, ultrasonication, steam explosion, with enzymatic and/or acid hydrolysis techniques. The later processes can be done by cellulolytic enzymes such as endo-1,4-D-glucanase, -glucosidase, exo-1,4-D-glucanase, or by using mineral acids such as H₂SO₄, HCl and HBr as well as ionic liquids. The role of these reagents is to destroy the amorphous regions leaving the crystalline domains. For purposes of this application, the use of the term nanocellulose is meant to include cellulose defined as microfibrillated cellulose (MFC) or cellulose microfibril (CMF), nanofibrillated cellulose (NFC) or cellulose nanofibril (CNF), microcrystalline cellulose (MCC) or cellulose microcrystal (CMC), nanocrystalline cellulose (NCC) or cellulose nanocrystal (CNC) and combinations thereof.

The presence of nanocellulose in wax dispersions was found to significantly reduce the formation of cracks and improve the performance of wax dispersions for (1) a better coverage of paper substrate with lower porosity and better water, water vapor, and gas barriers; (2) improved oil and grease resistance (OGR) performance; (3) improved resistance against elevated temperatures and high pressures for the coated paper substrates and molded fiber.

The coating is useful in applications where a wax coating is used to impart water resistance, water vapor resistance, oil and grease resistance, gas (e.g., oxygen) resistance, or other barrier properties to paper or paper board, and to improve the resistance of wax-coated paper substrates to hot pressing where elevated temperatures and high pressures is applied. The coating is also useful in fruit waxing where a wax coating is used to cover fruit and vegetables with improved water and water vapor barriers to prevent water loss and to extend the shelf life of fruit and vegetables.

Accordingly, it would be desirable to provide improved coating compositions having better barrier properties than are currently available.

### BRIEF DESCRIPTION OF THE DRAWINGS

The present disclosure will hereinafter be described in conjunction with the following drawing FIGURES, wherein like numerals denote like elements, and wherein:

FIG. 1, depicts SEM images of base paper (A), base paper coated with 10 gsm TopScreen™ BW 200 (a commercial vegetable wax-based dispersion with total solid content of about 40 wt. % with pH 8.0-10.5 and density 0.97 g/ml) (B), and base paper coated with 10 gsm TopScreen™ BW 200 with 0.8 wt. % MFC (C).

### BRIEF SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Provided is a coating composition that includes wax, a nanocellulose, for example, microfibrillated cellulose (MFC), nanofibrillated cellulose (NFC), microcrystalline cellulose (MCC), nanocrystalline cellulose (NCC) and combinations thereof; and water.

Also provided is a substrate having improved barrier properties comprising a substrate having a first and second surface disposed opposite one another, and a coating layer disposed on and in direct contact with the outermost surface, the innermost surface, or both surfaces of the substrate. The coating layer includes wax and nanocellulose, such as microfibrillated cellulose (MFC), nanofibrillated cellulose (NFC), microcrystalline cellulose (MCC), nanocrystalline cellulose (NCC), and combinations thereof.

The coating layer includes wax and nanocellulose, such as microfibrillated cellulose (MFC), nanofibrillated cellulose (NFC), microcrystalline cellulose (MCC), nanocrystalline cellulose (NCC), and combinations thereof.

Finally, provided is a method of providing improved barrier properties to a substrate. The method includes providing a substrate having an outermost surface and an innermost surface disposed opposite one another and applying a coating composition that is disposed on and in direct contact with the outermost surface, the innermost surface, or both surfaces of the substrate. The coating composition includes wax and one or more nanocellulose(s).

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims.

Furthermore, there is no intention to be bound by any expressed or implied theory presented in the preceding technical field, background, brief summary, or the following detailed description.

Unless specifically stated or obvious from context, as used herein, the term “about” is understood as within a range of normal tolerance in the art, for example within 2 standard deviations of the mean. “About” can be understood as within 10%, 5%, 1%, 0.5%, 0.1%, 0.05%, or 0.01% of the stated value. “About” can alternatively be understood as implying the exact value stated. Unless otherwise clear from the context, all numerical values provided herein are modified by the term “about.”

As used herein, the term “paper” refers to paper products including tissue paper, paper towels, paper board, and molded fiber/pulp products.

Provided is a coating composition that includes a wax dispersion and a nanocellulose selected from microfibrillated cellulose (MFC), nanofibrillated cellulose (NFC), microcrystalline cellulose (MCC), nanocrystalline cellulose (NCC), and combinations thereof.

Nanocelluloses exhibit an extraordinarily high specific surface area high aspect ratio and a complex interpenetrated network structure. The high surface area of the nanocelluloses is believed to interact with wax particles to stabilize the wax dispersions preventing the formation of cracks and offers improved film-forming capability for the wax dispersions.

Studies below indicated that when the current composition was applied to a substrate, better coverage of the article was obtained resulting in the substrate having reduced porosity, which led to improved oil, grease, gas, water, and water vapor barrier properties to the coated articles.

After wax formulations dry on the surface of a substrate, a wax-nanocellulose composite film is formed on the surface. Without wishing to be bound by theory, it is believed the cellulose fibrils or crystals bind and interact with the surface of wax particles holding them in the network of nanocellulose. This prevents wax migration under hot pressing.

In some aspects of the coating composition, the wax is in the form of a wax dispersion or a solid prior to combining with the nanocellulose. The wax can be any wax used in barrier coating compositions, such as wax from a paraffin, microcrystalline, polyethylene, polypropylene, Fischer-Tropsch, montan, palm, palm kernel, coconut, rapeseed, soybean, sunflower, castor, carnauba, beeswax, shellac, candelilla, sugar cane, rice bran, stearates, laurates, oleates, alkyl ketene dimer (AKD), ethylene-vinyl acetate copolymer (EVA), ethylene-propylene copolymer, and combinations thereof.

The coating composition also includes a nanocellulose chosen from microfibrillated cellulose (MFC), nanofibrillated cellulose (NFC), microcrystalline cellulose (MFC), and nanocrystalline cellulose (NCC), having a BET surface area of at least about 80 m²/g, and can be least about 100 m²/g.

In other aspects of the coating composition, the nanocelluloses have a xyloglucan absorption at 20° C. of at least 100 mg xyloglucan/(g nanocellulose), or can be at least about 120 mg xyloglucan/(g nanocellulose) (xyloglucan from Megazyme; Product code: P-XYGLN).

In other aspects of the coating composition, the nanocellulose has a viscosity of a 1.0 wt. % cellulose suspension is at least 300 cps (at 100 s⁻¹, 20° C.), and/or total fines of at least 60%.

In other aspects of the coating composition, the aspect ratio of the nanocellulose is greater than 5:1, or greater than 50:1.

In other aspects of the coating composition, the average fiber width of the nanocellulose is below 1 micron, or below 0.1 micron.

In other aspects of the coating composition, the nanocellulose is in suspension or paste form prior to combining with the wax.

In other aspects of the coating composition, the wax comprises from about 5 wt. % to about 80 wt. %, or from about 20 wt. % to about 50 wt. % of the total coating composition.

In yet other aspects of the coating composition, the nanocellulose comprises from about 0.1 wt. % to about 2.0 wt. %, or from about 0.4 wt. % to about 1.0 wt. % of the total coating composition.

In some aspects of the coating composition, the composition optionally comprises thermoplastic polymeric materials chosen from hydrocarbon resins, polypropylene and propylene copolymer, polyethylene and ethylene copolymer, polystyrene and styrene copolymers, polyester, acrylate polymer, styrene-maleic anhydride copolymer, their derivatives, and any combination thereof.

In other aspects of the coating composition, the composition further comprises starches, celluloses, lignins, hemicelluloses, pectins, proteins, rosins, shellac, alginates, xanthan gum, soy lecithin, lipids, disaccharides, monosaccharides, their derivatives, and combinations thereof.

In other aspects of the coating composition, the wax is chosen from a paraffin, microcrystalline, polyethylene, polypropylene, Fischer-Tropsch, montan, palm, palm kernel, coconut, rapeseed, soybean, sunflower, castor, carnauba, beeswax, shellac, candelilla, sugar cane, rice bran, stearates, laurates, oleates, alkyl ketene dimer (AKD), silicone wax, ethylene bis(stearamide), ethylene-vinyl acetate copolymer (EVA), ethylene-propylene copolymer, or combinations thereof.

Also provided is a coated substrate having improved barrier properties. The substrate has an outermost and innermost surface disposed opposite one another. A coating layer is disposed or applied onto and in direct contact with the outermost surface, the innermost surface, or both surfaces of the substrate. The coating layer is a composition composed of a wax dispersion, and a nanocellulose chosen from microfibrillated cellulose (MFC), nanofibrillated cellulose (NFC), microcrystalline cellulose (MCC), nanocrystalline cellulose (NCC), and combinations thereof.

In some aspects of the coated substrate, the coating composition contains a nanocellulose that is chemically and/or enzymatically modified via a reaction of amination, amidation, esterification, etherification, oxidation, silylation, carboxymethylation, epoxidation, carbamation, phosphorylation, polymer grafting and sulfonation.

In some aspects, the substrate is paper, paperboard, molded fiber, or fiber, such as cellulose fiber, regenerated cellulose, aramid, glass, carbon, polyester, wool, silk, and combinations thereof. The substrate has an outermost or first surface and an innermost or second surface disposed opposite one another. The coating composition is disposed on or applied onto and in direct contact with the outermost surface, the innermost surface, or both surfaces of the substrate.

In some aspects, the coated substrate is dried in drying facilities at a temperature of from about 10° C. to about 200° C., or from about 50° C. to about 130° C.

In other aspects, the substrate is a fruit or vegetable in which the coating composition is applied to the outer surface of the fruit or vegetable.

In other aspects of the substrate, the composition reduces the porosity of the substrate by about 50%, or about 75%, or up to about 100% compared with an uncoated substrate.

Also provided, is a method of providing improved barrier properties to a substrate. A substrate is provided in which a coating composition comprising a wax and a nanocellulose chosen from a microfibrillated cellulose (MFC), nanofibrillated cellulose (NFC), microcrystalline cellulose (MCC), nanocrystalline cellulose (NCC), and combinations thereof. The coating is applied or disposed onto at least one surface of the substrate thereby providing improved barrier properties and a decrease in porosity of the substrate.

In some aspects of the method, the substrate is a three-dimensional (3D) structure of fibers and/or fibrils in a network having air voids. In this case, the coating composition is disposed on and in direct contact with the fiber and/or fibril interfaces, which covers the surface of the fibers and/or fibrils and fills in the air voids in the 3D structure.

In some aspects of the method, the coating composition is applied to the surface of the substrate at a thickness of from about 1 μm to about 30 μm, or from about 3 μm to about 15 μm.

In some aspects of the method, the coating composition is applied to the surface of the substrate at a coating weight of from about 1 g/m² to about 30 g/m², or from about 3 g/m² to about 15 g/m². In other aspects of the method, the coating composition reduces the porosity of the substrate by about 5% to about 70% more compared with coating compositions that do not contain a nanocellulose.

In other aspects of the method, the coating composition is disposed on the surface of the substrate. The substrate is composed of fibers and/or fibrils having a 3D structure containing air voids; and wherein the coating composition when disposed on the surface of the substrate fills the air voids in the 3D structure to provide a coated substrate.

In yet other aspects of the method, the substrate has a 3D structure having air voids and the substrate is coated with a composition containing a wax and nanocellulose, wherein the wax comprises from about 0.1 wt. % to about 50 wt. %, or from about 3 wt. % to about 20 wt. % of the mass of the substrate.

### EXAMPLES

The following examples further illustrate the disclosure, but should not be construed to limit the scope of the disclosure in any way.

### Example 1—Preparation of Coating Formulation

The coating composition was formulated using TopScreen™ MF300 EU (Solenis LLC) and Valida® S23 1 C (Sappi). Cupforma Natura™ from Stora Enso (grammage of about 295 gsm) was used as the substrate for assessing the barrier properties of the coating composition. TopScreen™ MF300 EU is a commercial paraffin wax-based dispersion from Solenis with a total solid content of about 35%, and paraffin wax has a melting point of about 65° C. Valida® S23 1 C is a commercial fibrillated cellulose (MFC/NFC) with a solid content of 7.5-8.5%, total fines of about 92%, and xyloglucan absorption for Valida® S231C at 20° C. is about 190 mg xyloglucan/(g nanocellulose) (xyloglucan from Megazyme, product code: P-XYGLN). The coating composition was formulated by dispersing Valida® S231C in TopScreen™ MF300 EU via a T50 ULTRA-TURRAX® (IKA) at a speed of 8000 rpm for 5 minutes at room temperature. The coating on the base paper was performed on only one side of the base paper using a Laboratory K control coater (model 101, RK PrintCoat Instruments Ltd.) at room temperature. Coated paper was dried in an oven at 105° C. for 3 min. After drying, the coated paper was kept in a climate room (23° C., 50% RH) for 24 hours before testing.

Barrier properties testing was performed in the climate room at 23° C. and relative humidity of about 50%. Bendtsen porosity was performed with a test pressure of 1.47 kPa on the Bendtsen apparatus according to ISO 5636-3:2013. The oil resistance of coated paper samples was performed using colored peanut oil in the climate room (23° C., 50% RH) based on visual observation of the time taken for oil to penetrate through the coated sheets. Water absorptiveness of the coated paper samples was performed in the same environment (23° C., 50% RH) using a Cobb method according to ISO 535:2023.

The Bendtsen porosity, oil holdout, Cobb 1800 of the base paper, and coated paper samples are shown in Table 1.

TABLE 1
Bendtsen Porosity, Oil Holdout, Cobb 1800 Results

| | Bendtsen | Oil holdout | Cobb |
|---|---|---|---|
| | Porosity | (23° C., | 1800 |
| Sample | (mL/min) | 50% RH) | (g/m²) |
| Base paper without coating | 501 ± 28 | < 30 seconds | 77 |
| Base paper coated with 10 gsm | 284 ± 16 | < 30 seconds | 60 |
| TopScreen ™ MF300 EU | | | |
| Base paper coated with 10 gsm | 21 ± 8 | 5 minutes | 58 |
| (TopScreen ™ MF300 EU+ | | | |
| 0.2 wt. % MFC) | | | |
| Base paper coated with 10 gsm | 13 ± 5 | 10 minutes | I |
| (TopScreen ™ MF300 EU+ | | | |
| 0.4 wt. % MFC) | | | |
| Base paper coated with 10 gsm | 15 ± 8 | 60 minutes | I |
| (TopScreen ™ MF300 EU+ | | | |
| 0.6 wt. % MFC) | | | |
| Base paper coated with 10 gsm | 8 ± 2 | >120 minutes | 58 |
| (TopScreen ™ MF300 EU+ | | | |
| 0.8 wt. % MFC) | | | |

Results shown in Table 1, indicate addition of nanocellulose in a paraffin wax dispersion could prevent crack formation, and paper substrates coated with such coating composition show reduced porosity and improved water, oil, and gas barriers compared to the coating composition without nanocellulose.

### Example 2—Preparation of Coating Formulation

The coating composition was formulated using TopScreen™ BW 200 (Solenis LLC) and Valida® S231C (Sappi). TopScreen™ BW 200 is a commercial vegetable wax-based dispersion with total solid content of about 40 wt. % and a pH of about 8.0 to 10.5 and a density of 0.97 g/ml. Valida® S23 1 C is a commercial fibrillated cellulose (MFC/NFC) with a solid content of 7.5-8.5%, total fines of about 92%, and xyloglucan absorption for Valida® S231C at 20° C. is about 190 mg xyloglucan/(g nanocellulose) (xyloglucan from Megazyme, product code: P-XYGLN). The wax in the dispersion has a melting point of about 68° C. Cupforma Natura™ from Stora Enso (grammage of about 295 gsm) was used as the substrate for assessing the barrier properties of the coating composition.

The coating formulation preparation, coating on the base paper, and barrier performance were carried out in the same method and conditions as described in Example 1. Morphology observation was performed on both base and coated paper samples using a Hitachi® SU3500 scanning electron microscope (SEM). The Bendtsen porosity, oil resistance, and water absorption for the base paper and coated paper samples are shown in Table 2.

TABLE 2
Results of Bendtsen Porosity, oil holdout, and Cobb 1800

| Sample | Bendtsen | Oil holdout | Cobb |
|---|---|---|---|
| | Porosity | (23° C., | 1800 |
| | (mL/min) | 50% RH) | (g/m²) |
| Base paper | 501 ± 28 | <30 seconds | 77 |
| without coating | | | |
| Base paper coated | 370 ± 33 | <30 seconds | 32 |
| with 10 gsm | | | |
| TopScreen ™ BW 200 | | | |
| Base paper coated | 41 ± 12 | >140 hours | 4 |
| with 10 gsm | | | |
| (TopScreen ™ BW | | | |
| 200 + 0.8 wt. % MFC) | | | |

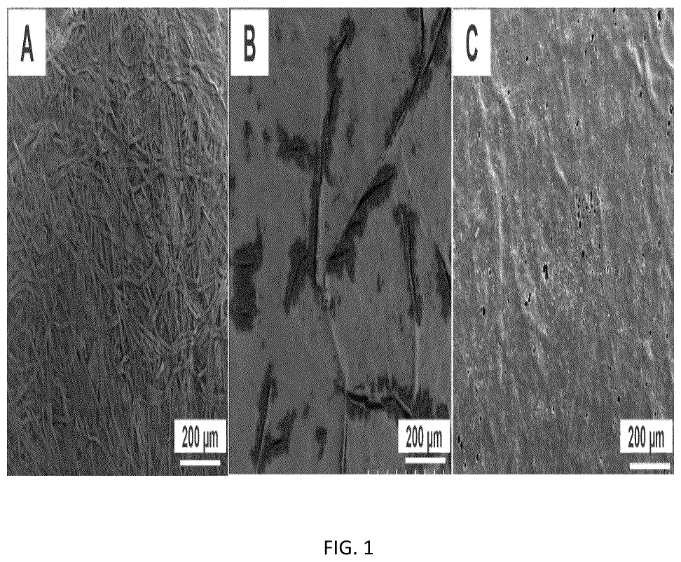

Results shown in Table 2 and FIG. 1, indicate the addition of nanocellulose in a vegetable wax dispersion prevents crack formation, and paper substrates coated with such coating compositions show reduced porosity and improved water, oil, and gas barrier holdout compared to the coating composition without nanocellulose.

### Example 3—Impact of Defibrillation Degree of MFC on the Performance of TopScreen™ BW 200

In this example, the coating compositions were formulated using TopScreen™ BW 200 and three grades of MFC: (1) Sappi Valida® S231C having a xyloglucan absorption of about 190 mg/(g MFC) (at 20° C.), and a specific surface area of about 160 m²/g (BET); (2) Borregaard Exilva® FOI V having a xyloglucan absorption of about 160 mg/(g MFC) (at 20° C.), and a specific surface area of about 150 m²/g (BET); and (3) Sappi Valida® L having a xyloglucan absorption of about 100 mg/(g MFC) (at 20° C.), and a specific surface area of about 100 m²/g (BET). (Xyloglucan Tamarind from Megazyme was used in the measurement, Product code: P-XYGLN). TopScreen™ BW 200 is a commercial vegetable wax-based dispersion from Solenis with total solid content of about 40 wt. % with pH 8.0-10.5 and density 0.97 g/ml.

The coating formulation preparation, coating on the base paper, and barrier properties were performed in the same procedure and methods described in Example 1. Cupforma Natura™ paper from Stora Enso (grammage of about 295 gsm) was used as the substrate for assessing the barrier properties of the coating compositions.

TABLE 3
Oil resistance of base paper and coated base paper samples

| | Oil holdout |
|---|---|
| Sample | (23° C., 50% RH) |
| Base paper without coating | <30 seconds |
| Base paper coated with 10 gsm | <30 seconds |
| TopScreen ™ BW200 | |
| Base paper coated with 10 gsm | >140 hours |
| (TopScreen ™ BW200 + 0.8 wt. % | |
| MFC of Valida ® S23 1 C) | |
| Base paper coated with 10 gsm | 24-72 hours |
| (TopScreen ™ BW200 + 0.8 wt. % | |
| MFC of Exilva ® F01 V) | |
| Base paper coated with 10 gsm | <20 minutes |
| (TopScreen ™ BW200 + 0.8 wt. % | |
| MFC of Valida ® L) | |

As can be seen by the results shown in Table 3, the formulations that included the MFC showed significantly improved barrier properties over the base paper or that coated only with a wax. The higher the specific surface area the MFC has, indicated by the xyloglucan absorption value, the better oil resistance for the coating compositions could provide to the substrate.

### Example 4—Resistance to Hot Pressing

In this example, the resistance to hot pressing was studied using the following conditions:

Wax-coated paper substrates (14 cm×14 cm) were mounted on top of a dry-formed cellulose fiber sheet (grammage of about 650 gsm, dimension 14 cm×14 cm×0.1 cm) using a carver press to evaluate the stability of the coated paper samples when they were exposed to high temperature and high pressure, and also to evaluate whether pre-coated paper sheets can be efficient to provide barrier properties for molded fibers. Before pressing, 1.0 g 15% C-Film 07312 (Cargill) was applied to the back of the coated paper using a rubber spatula for gluing the coated paper together with the molded fiber sheet during pressing. The hot pressing was performed using a Carver bench top laboratory manual press (CARVER®, Model: 4122) under a clamping force of about 10 tons at 140° C. for 2 min. The coating composition was formulated using TopScreen™ BW 200 and Valida® S23 1 C (Sappi) according to the procedure described in Example 1. TopScreen™ BW 200 is a commercial vegetable wax-based dispersion from Solenis with total solid content of about 40 wt. % with pH 8.0-10.5 and density 0.97 g/ml. Valida® S231C is a commercial fibrillated cellulose (MFC/NFC) from Sappi with a solid content of 7.5-8.5%, total fines of about 92%, and xyloglucan absorption for Valida® S231C at 20° C. is about 190 mg xyloglucan/(g nanocellulose) (xyloglucan from Megazyme, product code: P-XYGLN). Unbleached Kraft paper from Graphic Packaging Internal (GPI) with a grammage of about 40 gsm was selected for this study, which has Bendtsen porosity of about 350 mL/min. Coating and barrier properties evaluation followed the same protocol described in Example 1.

TABLE 4
Oil resistance performance of the coated paper and
molded fiber sheet before hot pressing

| | Oil holdout | Bendtsen porosity |
|---|---|---|
| Sample from hot pressing | (23 degrees, 50% RH) | (mL/min) |
| GPI paper | <1 min | 350 |
| GPI paper coated with 10 | >140 h | 30 |
| gsm TopScreen ™ BW200 | | |
| GPI paper coated with 10 | >140 h | 0 |
| gsm (TopScreen ™ | | |
| BW200 + 0.8 wt. % MFC) | | |
| Molded fiber sheet | <1 min | 110 |

TABLE 5
Oil resistance performance of the wax-precoated paper
laminated with molded fiber sheet from hot pressing

| | Oil holdout |
|---|---|
| Sample from hot pressing | (23 degrees, 50% RH) |
| GPI paper pre-coated with 10 gsm | <5 min |
| TopScreen ™ BW200 laminated with | |
| molded fiber sheet | |
| GPI paper pre-coated with 10 gsm | >28 h |
| (TopScreen ™ BW200 + 0.8% MFC) | |
| laminated with molded fiber sheet | |

Results shown in Table 4 and Table 5, indicate addition of nanocellulose in a wax dispersion improves the resistance of wax-coated substrate against elevated temperatures and pressures without completely losing the barrier properties of wax-coated paper substrate.

Laminated structures with nanocellulose containing wax-coated paper and molded fibers from hot pressing show better barrier properties than the coating composition without the addition of nanocellulose.

### Supplemental Data:

### Example 5—Improved Thermal Resistance and Barrier Performance During Coating Application

The process and procedures used in Example 2, were used in this example except that TopScreen™ BW 200 was replaced with TopScreen™ BW 100 (Solenis LLC). TopScreen™ BW100 is a commercial vegetable wax-based dispersion with a total solid content of about 50 wt. % and a pH of about 8.0 to 10.5. The wax in the dispersion has a melting point of about 48° C.

TABLE 6
Thermal Resistance and Barrier Performance During Coating Application

| | Drying | Bendtsen | Cobb |
|---|---|---|---|
| | temperature (° C.) | Porosity | 1800 |
| Coating | for 1 minute | (mL/min) | (g/m²) |
| TopScreen ™ BW 100 | 95 | 89 ± 19 | 39 ± 4 |
| | 100 | 245 ± 16 | 32 ± 3 |
| | 110 | 259 ± 34 | 39 ± 4 |
| | 120 | 172 ± 11 | 48 ± 3 |
| TopScreen ™ | 95 | 7 ± 6 | 8 ± 1 |
| BW100 + MFC | 100 | 6 ± 4 | 9 ± 1 |
| | 110 | 6 ± 4 | 9 ± 2 |
| | 120 | 6 ± 4 | 8 ± 2 |

Results shown in Table 6, indicate addition of nanocellulose in a vegetable wax dispersion could prevent crack formulation, and paper substrates coated with such coating composition show reduced porosity and improved water barriers compared to the coating composition without nanocellulose.

In addition, the addition of nanocellulose in the coconut wax dispersion could improve the stability of the coating under different drying conditions. The wax dispersion shows stable and good water barrier performance over a wide drying temperature from 95° C. to 120° C., while the coating composition without nanocellulose could be affected greatly by the drying temperatures.

### Example 6—Effect of Wax Ingredients on Barrier Performance

Processes and procedures used in this example were the same as used in Example 2, except that TopScreen™ BW 200 was replaced with TopScreen™ BW 300 (Solenis LLC). TopScreen™ BW300 is a commercial vegetable wax-based dispersion with a total solid content of about 40 wt. % and a pH of about 8.0 to 10.5 and a density of about 0.97 g/mL. The wax in the dispersion has a melting point of about 68° C. The formulations outlined in Table 7, were also used to test wax ingredients impact on barrier performance.

TABLE 7
Oil Resistance Of Coated Base Paper Samples

| | Bendtsen | Cobb | Oil holdout |
|---|---|---|---|
| | Porosity | 1800 | (23° C., |
| Sample | (mL/min) | (g/m²) | 50% RH) |
| Palm Oil, Rapeseed Oil, Stabilizer | 460 ± 41 | 91 ± 1 | <1 |
| Additives of Alcohol Oxalate, and | | | |
| Potassium Behenate | | | |
| Palm Oil, Rapeseed Oil, Stabilizer | 176 ± 31 | 102 ± 1 | 5-10 |
| Additives of Alcohol Oxalate, and | | | |
| Potassium Behenate + 0.8 wt. % MFC | | | |
| Rapeseed Wax/Lignosulfonate | 395 ± 25 | 80 ± 3 | <1 |
| Rapeseed Wax/Lignosulfonate + | 2 ± 2 | 81 ± 3 | >30 |
| 0.8 wt. % MFC | | | |
| TopScreen ™ BW 300 | 200 ± 35 | 43 ± 10 | <1 |
| TopScreen ™ BW300 + | 20 ± 10 | 15 ± 6 | >30 |
| 0.8 wt. % MFC | | | |

Results shown in Table 7, indicate addition of nanocellulose in a wax dispersion could prevent crack formation and the barrier performance of coated substrates also depends on other additives present in the coating formulations. The presence of hygroscopic ingredients (e.g., lignosulfonate, alcohol oxalate) leads to low water resistance without improvement in water barriers after adding nanocellulose to the coating composition. However, the other additives used in TopScreen™ BW 300 with no or low hygroscopic ingredients could result in both improved water and oil resistance.

The examples show that the advantages of the new composition include (1) microfibrillated cellulose is a bio-based and renewable material offering a bio-based solution for improved barrier performance for a wax-based formulation, (2) making it possible to produce formulations with a high bio-content or even potentially to produce fully bio-based barrier coatings for paper or paper-based products, and (3) the processing is very simple, one only needs to blend in the additives during a wax dispersion preparation or after a wax dispersion preparation.

In addition, the examples show the improvement in barrier performance was highly dependent on the quality (i.e., surface area/defibrillation degrees) of the microfibrillated cellulose (MFC) and type of other additives in wax emulsion preparation. The higher defibrillation degrees the MFC has, the better barrier properties (i.e., gas, water, and oil barrier) the coated paper articles have.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. A coating composition comprising:
a wax; a nanocellulose chosen from microfibrillated cellulose (MFC), nanofibrillated cellulose (NFC), microcrystalline cellulose (MCC), nanocrystalline cellulose (NCC), and combinations thereof; and water.

2. The coating composition according to claim 1, wherein the nanocellulose has a BET surface area of at least about 80 m²/g, or at least about 100 m²/g.

3. The coating composition according to claim 1, wherein the nanocellulose has a xyloglucan absorption at 20° C. of at least 100 mg xyloglucan/(g nanocellulose), or at least 120 mg xyloglucan/(g nanocellulose).

4. The coating composition according to claim 1, wherein the nanocellulose has a viscosity of a 1.0 wt. % cellulose suspension is at least 300 cps (at 100 s⁻¹, 20° C.), and/or total fines of at least 60%.

5. The coating composition according to claim 1, wherein the aspect ratio of nanocellulose is greater than 5:1, or greater than 50:1.

6. The coating composition according to claim 1, wherein the average fiber width of the nanocellulose is below 1 micron, or below 0.1 micron.

7. The coating composition according to claim 1, wherein the nanocellulose is in suspension or paste form prior to combining with the wax.

8. The coating composition according to claim 1, wherein the nanocellulose comprises from about 0.1 wt. % to about 2.0 wt. %, or from about 0.4 wt. % to about 1.0 wt. % of the total coating composition.

9. The coating composition according to claim 1, optionally comprising thermoplastic polymeric materials.

10. The coating composition according to claim 9, wherein the thermoplastic polymeric material is chosen from hydrocarbon resins, polypropylene and propylene copolymer, polyethylene and ethylene copolymer, polystyrene and styrene copolymers, polyester, styrene-maleic anhydride copolymer, derivatives, and combinations thereof.

11. The coating composition according to claim 1, further comprising starches, celluloses, lignins, hemicelluloses, pectins, proteins, rosins, alginates, xanthan gum, soy lecithin, lipids, disaccharides, monosaccharides, their derivatives, and combinations thereof.

12. The coating composition according to claim 1, wherein the wax is in the form of a dispersion or a solid prior to combining with the nanocellulose.

13. The coating composition according to claim 1, wherein the wax is chosen from paraffins, microcrystalline, Fischer-Tropsch, polyethylenes, polypropylenes, montan, palm, palm kernel, coconut, rapeseed, soybean, sunflower, castor, carnauba, beeswax, shellac, candelilla, sugar cane, rice bran, stearates, laurates, oleates, alkyl ketene dimer (AKD), silicone, ethylene bis(stearamide), ethylene-vinyl acetate copolymer (EVA), ethylene-propylene copolymer, and combinations thereof.

14. A substrate having improved barrier properties comprising:
a substrate; and a coating layer disposed on and in direct contact with the surface of the substrate;
wherein the coating layer comprises a wax; and a nanocellulose chosen from microfibrillated cellulose (MFC), nanofibrillated cellulose (NFC), microcrystalline cellulose (MCC), nanocrystalline cellulose (NCC), and combinations thereof.

15. The substrate according to claim 14, wherein the substrate is chosen from paper, paperboard, fiber, molded fibers, fibrils, cellulose fiber, regenerated cellulose, aramid, glass, carbon, polyester, wool, silk, and combinations thereof.

16. The substrate according to claim 14, wherein the substrate is a three-dimensional (3D) structure of fibers and/or fibrils, wherein the fibers and/or fibril form a network containing air voids.

17. The substrate according to claim 14, wherein the composition reduces the porosity of the substrate by about 50%, or about 75%, or up to about 100%, when compared with an uncoated substrate.

18. A method of providing improved barrier properties to a substrate comprising:
a) providing a substrate;
b) disposing on the surface of the substrate a coating composition according to claim 1, wherein the composition is disposed on and in direct contact with at least one surface of the substrate.

19. The method according to claim 18, wherein the substrate is composed of fibers and/or fibrils having a 3D structure containing air voids; and wherein the coating composition when disposed on the surface of the substrate fills the air voids in the 3D structure.
